(19) United States
(12) Patent Application Publication
(10) Pub. No.: US 2022/0082088 A1
(43) Pub. Date: Mar. 17, 2022

(54) TRANSLATIONALLY MOVABLE WIND POWER PLANT

(71) Applicant: Jan Franck, Weidenberg (DE)

(72) Inventor: Jan Franck, Weidenberg (DE)

(21) Appl. No.: 17/535,007

(22) Filed: Nov. 24, 2021

Related U.S. Application Data
(63) Continuation-in-part of application No. 16/385,085, filed on Apr. 16, 2019, now abandoned.
Application No. 16/385,085 is a continuation-in-part of application No. 15/504,860, filed on Feb. 17, 2017, now abandoned.

(30) Foreign Application Priority Data
Aug. 18, 2014 (DE) 10 2014 012 048.1

(51) Int. Cl. F03D 9/32; F03D 9/25; B60L 8/00; F03D 9/19; B60L 53/54; B60L 53/52

(52) U.S. Cl. CPC F03D 9/32; F03D 9/25; B60L 8/006; B60L 2210/46; B60L 53/54; B60L 53/52; F03D 9/19

(57) ABSTRACT

The invention refers to a wind generator onboard of a road vehicle, the wind generator comprising: at least one wind wheel which is mounted onboard of a road vehicle to be rotatable around a rotational axis, the at least one wind wheel comprising at least one or more blade configured to convert flow energy of wind into rotational energy, at least one generator, the at least one generator being coupled to a hub or shaft of the at least one wind wheel or to an output shaft of a gear connected the at least one wind wheel, the at least one generator being configured to convert the rotational energy into electrical energy, wherein a center of gravity of the wind wheel, together with a hub and rotor shaft and rotatable parts of the generator or of the gear which are coupled to the hub or rotor shaft and rotate around the same rotational axis, is translationally movable in a horizontal or approximately horizontal direction together with the road vehicle in the direction of travel, wherein the at least one generator is either a direct current generator or is an alternating current generator with an output side of the at least one generator being coupled to a rectifier so as to provide the electrical energy as a direct current output, wherein at least one energy storage is coupled to the direct current output of the at least one generator or to the direct current output of the rectifier, for receiving and storing the electrical energy, wherein the extension of the at least one wind wheel parallel to its rotational axis is smaller than the extension of the at least one wind wheel transversely to its rotational axis, wherein, in the direction of travel of the road vehicle, there is no cascade of more than one wind wheel, i.e. no two wind wheels are arranged behind each other, and wherein the shape and size of the body of the vehicle are neither modified or increased by the wind generator nor affected by extensions fixed to the body of the vehicle housing the wind generator.

### REFERENCE TO PENDING PRIOR PATENT APPLICATIONS

This patent application:
(i) is a continuation-in-part of pending prior U.S. patent application Ser. No. 16/385,085 filed at Apr. 16, 2019 by Jan Franck for a TRANSLATIONALLY MOVEABLE WIND POWER PLANT (Attorney's Docket No. KUCH-81 CIP), which patent application, in turn:
   (1) is a continuation-in-part of prior U.S. patent application Ser. No. 15/504,860 filed at Feb. 17, 2017 by Jan Franck for WIND TURBINE WHICH CAN BE MOVED IN TRANSLATION (Attorney's Docket No. KUCH-81), which patent application, in turn,
      (a) is a 371 national stage entry of International (PCT) Patent Application No. PCT/IB2015/001384, filed Aug. 18, 2015 by Jan Frank for WIND TURBINE WHICH CAN BE MOVED IN TRANSLATION, which patent application, in turn, claims benefit of German Patent Application No. DE 10 2014 012 048.1, filed Aug. 18, 2014.

The four (4) above-identified patent applications are hereby incorporated herein by reference.

### FIELD OF THE INVENTION

The invention is directed to a wind generator onboard of a road vehicle, the wind generator comprising a wind turbine which is mounted so that it is rotatable about a horizontal or approximately horizontal rotational axis, and which has one or more blades or other wind-guiding surfaces for converting flow energy of the wind into rotational energy, and at least one generator, coupled to the hub or shaft of the wind turbine, for converting the rotational energy into electrical energy.

### BACKGROUND OF THE INVENTION

To supplement and to reduce consumption of existing fuels, ever since the so-called energy transition there has also been increasing use of renewable energies, in particular wind energy.

However, the wind flow in many areas is somewhat sporadic, and it is not uncommon for periods with high wind to be interspersed with calm or windless phases. In addition, during periods with low wind, the massive rotor of a wind power plant often cannot be set in motion, so that wind energy plants generally are able to deliver energy only at higher wind speeds.

On the other hand, a travelling road vehicle is experiencing a rather strong air resistance. As seen from a reference system connected to the body of the travelling road vehicle, this air resistance results in a rather strong airstream bouncing against the front face of the road vehicle and flowing from the front side of the road vehicle to the rear side thereof. So, it has already been attempted to mount a wind generator onboard of a road vehicle. On the other hand, such wind generator shall be exposed to the airstream of the travelling road vehicle, in order to gather some energy of such airstream. For example, according to US 2008/0296904 A1, a great number of tubes each housing a wind generator are to be retrofitted to the outside of a road vehicle or of another moving object. These tubes mounted to the outside surface of the road vehicle increase the dimensions of the car body and therefore increase the air resistance of such road vehicle, too. Therefore, the gathered energy has to be paid dearly by a higher fuel consumption of the road vehicle.

A similar disadvantage has to be tolerated at another construction disclosed in U.S. Pat. No. 7,808,121 B1, where wind wheels are mounted within a housing which is fixed to the roof of the road vehicle. On the other hand, such a housing rises far beyond the roof of the road vehicle and produces an additional air resistance in case of travel, and therefore, the fuel consumption of such road vehicle is substantially higher than without such roof extensions.

Another problem with US 2008/0296904 A1 as well as with U.S. Pat. No. 7,808,121 B1 is that in most embodiments disclosed in these documents, there are several wind generators installed behind each other in the direction of travel of the road vehicle. Hence, a wind wheel located in front of another wind wheel produces a slipstream so that the airstream for the following wind wheels is reduced and therefore, the efficience of the following wind generators is reduced.

The same is true for the arrangement disclosed in U.S. Pat. No. 7,665,554 B1. There, a plurality of air-drive electric generators are mounted within a common air conduit one behind the other along a common axis pointing in the direction of travel. Here, the foremost wind wheel produces a slipstream for all following wind wheels, and the second wind wheel additionally produces a further slipstream for the third an all following wind wheels, and so on. Therefore, the efficience of the wind generators is successively reduced.

Furthermore, as can be seen from the drawing of U.S. Pat. No. 7,665,554 B1, the common air conduit for the wind generators requires a great amount of space within the car and the length of the motor hood is more as double the diameter of a front wheel, although it does not house the motor of the vehicle at all. This tremendous waste of space raises the weight of the road vehicle, and therefore results in an additional fuel consumption of the road vehicle.

A similar drawback occurs at the U.S. Pat. No. 5,680,032. There, an air intake duct extends completely over the area of the front grill of the vehicle, and an air discharge duct either extends to the rear of the vehicle or to both sides of the car body. Altogether, such duct system not only consumes a high amount of space within the engine compartment, but extends beneath the chassis and underbody of the vehicle up to the tail end of the car, and therefore leads to a substantially higher weight of the vehicle, which in turn raises the fuel consumption of the vehicle.

Furthermore, this document does not use a wind wheel in the sense of the present invention, but a cylindrical rotor like a Savonius Rotor where shovel-like protrusions on the lateral surface of the cylinder extend in a lengthwise direction of the cylinder. Such an arrangement produces an obstacle thwarting the air stream in the duct system between the air intake duct and the air discharge rather completely. The insofar blocked air stream raises the air resistance of the road vehicle and leads to a raised fuel consumption.

The auxiliary generator of electrical energy disclosed in US 2016/0153308 A1 suffers from a similar handicap, because this generator uses a cylindrical rotor like a Savonius Rotor where shovel-like protrusions on the lateral surface of the cylinder extend in a lengthwise direction of the cylinder, too. Although such an arrangement constitutes a rather significant obstacle for the airstream braking, the electrical output is limited.

Altogether, all known documents of the prior art disclose arrangements with a raised air resistance and/or weight of the vehicle, while the gathered electrical energy is poor and cannot redeem the raised fuel consumption of the vehicle resulting from the raised air resistance and/or weight of the vehicle.

### SUMMARY OF THE INVENTION

The disadvantages of the described prior art have resulted in the object of the invention, to design a wind generator such that the incident relative wind speed is, or can be made to be, as high as possible, while the fuel consumption of the road vehicle shall not be deteriorated in a similar amount.

This object is achieved by a wind generator onboard of a road vehicle, the wind generator comprising:
at least one wind wheel which is mounted onboard of a road vehicle to be rotatable around a rotational axis, the at least one wind wheel comprising at least one or more blade configured to convert flow energy of wind into rotational energy,
at least one generator, the at least one generator being coupled to a hub or shaft of the at least one wind wheel or to an output shaft of a gear connected the at least one wind wheel, the at least one generator being configured to convert the rotational energy into electrical energy,
wherein a center of gravity of the wind wheel, together with a hub and rotor shaft and rotatable parts of the generator or of the gear which are coupled to the hub or rotor shaft and rotate around the same rotational axis, is translationally movable in a horizontal or approximately horizontal direction together with the road vehicle in the direction of travel,
wherein the at least one generator is either a direct current generator or is an alternating current generator with an output side of the at least one generator being coupled to a rectifier so as to provide the electrical energy as a direct current output,
wherein at least one energy storage is coupled to the direct current output of the at least one generator or to the direct current output of the rectifier, for receiving and storing the electrical energy,
wherein the extension of the at least one wind wheel parallel to its rotational axis is smaller than the extension of the at least one wind wheel transversely to its rotational axis,
wherein, in the direction of travel of the road vehicle, there is no cascade of more than one wind wheel, i.e. no two wind wheels are arranged behind each other, and
wherein the shape and size of the body of the vehicle are neither modified or increased by the wind generator nor affected by extensions fixed to the body of the vehicle housing the wind generator.

Thereby, the air resistance of the road vehicle is not increased by a greater size of the body of the vehicle or by extensions fixed to the body of the vehicle housing the wind generator. Furthermore, as there is no cascade of several wind wheels behind each other, neither in the direction of travel of the road vehicle nor in the direction of the airflow through the wind wheels, the obstacle of the wind wheel is minimized while the efficiency of the wind generator is maximized. A further measure to minimize the air resistance is to use a wind wheel with a shorter extension in the direction of its rotational axis compared to its extension in a transverse direction.

Furthermore, this construction allows a dimensioning of the body of the vehicle, where the distance between the wheel case of the front wheel of the road vehicle and the regarding front door is less than the diameter of the front wheel, or is less than the radius of the front wheel. This, in turn, leads to a reduced length of the motor hood and thereby to a minimized length of the overall body and finally to a reduced weight of the road vehicle.

A further measure in order to improve the efficiency of the wind generator is that the air leaving the at least one wind wheel is fed via an outlet air duct along a direction towards or nearby at least one motor or engine of the road vehicle to a region beneath the body of the road vehicle, where the pressure is lowered beneath the atmospheric pressure in case of movement of the road vehicle. By use of such an outlet air duct, it is possible to direct the air flowing out of the wind wheel to an area of the body, where the where the pressure is lowered beneath the atmospheric pressure in case of movement of the road vehicle.

At the same time, the inflowing air is fed to the at least one wind wheel via an inlet air duct from an inlet mouth at the front side of the road vehicle, where the pressure is raised above the atmospheric pressure in case of movement of the road vehicle.

Therefore, while there is no pressure difference between the front and rear side of the wind wheel as long as the road vehicle is at rest, in case of movement of the road vehicle, the pressure difference between the inlet mouth of the inlet air duct and the outlet mouth of the outlet air duct raises together with an increasing speed of the road vehicle, thereby raising the pressure difference between the front and rear side of the wind wheel, too. On the other hand, air is allowed to flow away from the front side of the road vehicle into the inlet mouth, whereby the air resistance of the road vehicle is lowered, while the air emanating at the outlet mouth finds a lowered pressure and is able to feed additional air into such areas whereby turbulences there can be reduced.

On the other hand, this is done without demanding a substantial space in the engine compartment. Instead, the air is moved towards, nearby or past the motor of the road vehicle, and the engine or motor can be placed either in the engine compartment as is usual, or can be placed at the wheel suspension like in modern electric cars.

In case of movement of the road vehicle, the pressure is lowered beneath the atmospheric air pressure especially in the area beneath the chassis or underbody of the road vehicle. There, the air leaving the wind wheel can be discharged in a diffuse way into this area without producing additional turbulences or even by reducing turbulences there, as pressure differences are reduced which otherwise would cause turbulences.

The invention tends to avoid elongated air ducts as those would on the one hand intensify the air resistance and would on the other hand lead to an increased weight of the vehicle body. Therefore, the invention attempts to place the outlet mouth nearby the inlet mouth, for example not more than 2 m away from each other, especially not more than 1.5 m away from each other, in particular not more than 1.2 m from each other, in all cases measured from the farthest points of the inlet mouth and outlet mouth.

In view of this, an optimum location for the outlet mouth of the outlet air duct can be found behind a front spoiler of the road vehicle or in the wheel case of one of the front wheels of the road vehicle. In these areas, the pressure is lowered beneath the atmospheric pressure when the road vehicle moves. In one of the wheel cases for the front wheels, the pressure is lowered especially in the area of the rear half of the wheel case, because when the regarding front wheel detaches from the ground surface, the approaching space has to be filled by air, and up to then the pressure is lowered there and sucks air from the upper area of the wheel case. The optimum locations for an outlet mouth are in the upper area of the wheel case or at the medial side of the wheel case, that is at the wall separating the wheel case from the engine compartment. From there, large amounts of air can be drawn through the wind wheel, thereby simultaneously improving the yield of produced electrical energy as well as reducing turbulences in the area of the front wheels which would otherwise compromise the air resistance of the road vehicle.

If the outlet mouth of the outlet air duct is located in the wheel case or behind a front spoiler beneath the forwardmost part of the chassis or the underbody, the outlet mouth should be covered by a grid in order to protect the wind wheel from debris.

Furthermore, if the outlet mouth of the outlet air duct is located in the wheel case, it should be designed such that the air emanating therefrom is directed towards the wheel brake. By this, the air discharged at the outlet mouth can furthermore be used to cool the brakes of the car, especially disc brakes, which could otherwise overheat in case of a downhill travel.

While the outlet air duct between the wind wheel and the outlet mouth is preferably curved, in order to deflect the stream of air to the bottom of the chassis or underbody or into a wheel case, the inlet air duct should be straight in an area between the inlet mouth and the wind wheel, in order to hinder the air stream as less as possible.

Furthermore, the inlet air duct between the inlet mouth at the front side of the road vehicle and the wind wheel should wider at the inlet mouth than at the wind wheel. Such an arrangement forces the air stream to increase its velocity as the cross section of the stream narrows, and a higher stream velocity produces a higher pressure at the wind wheel, thereby improving the yield of electric energy produced by the generator of the wind wheel.

In order to feed the air from the lower area of the front side of the vehicle to the upper area of a wheel case of a front wheel, the inlet air duct can be ascending in an area between the inlet mouth and the wind wheel.

Furthermore, the inlet mouth may be equipped with a device for closing the inlet air duct at the inlet mouth. Such an arrangement is useful if the inlet mouth is located at an streamlined area of the body of the vehicle, and then the streamline is not interrupted by the inlet mouth. Accordingly, the cd value is optimized, which can be advantageous if the road vehicle shall be driven at maximum speed or shall be accelerated as strong as possible. To achieve this, the device for closing the inlet air duct at the inlet mouth can be designed as a lamella-like curtain whose lamellae are open for a normal incident flow direction of the air, but closed to stop the incident flow of air onto the wind wheel. It is conceivable to provide a plurality of mutually parallel lamellae, each having a horizontal longitudinal axis. Each lamella is mounted so that it is pivotable about one of its longitudinal edges, in particular about the top longitudinal edge in each case, for example in a lateral mounting. Under usual flow conditions, the lamellae are controlled by the wind to assume an approximately horizontal position, so that the interspaces between the lamellae are open and the wind can flow essentially unhindered up to the wind turbine in order to drive it in the usual rotational direction. Under “unusual” flow conditions, however, the lamellae fall into an approximately vertical plane; however, due to stop elements at that location the lamellae are not able to pivot further, and instead remain in this plane and therefore jointly close the entire incident flow area, i.e., keep the unfavorable wind away from the wind turbine. The wind turbine therefore is not decelerated. In addition, the back-pressure of the wind which now acts on the lamellae may be used as a translational drive until the wind turbine in question, which is translationally accelerated in this way, once again reaches an area with typical wind conditions, and can then draw rotational energy from same, which is ultimately converted into electrical energy.

The at least one wind wheel is provided with a front side facing towards the airflow coming into the wind wheel, and with a rear side facing in the direction of the air leaving the wind wheel, and the rotational axis of the wind wheel should be parallel to the direction of the air flow between the front side and the rear side of the wind wheel. In such an arrangement, all blades of the wind wheel are permanently exposed to the air stream and can permanently deliver a rotational force at the axis of rotation of the wind wheel.

In order to gain a maximum yield an electric energy, the wind generator and/or the wind wheel are/is mounted between an inlet air duct and an outlet air duct in such a way that the front side of the wind wheel faces the inlet air duct and the rear side of the wind wheel faces the outlet air duct. Furthermore, the inlet air duct and the outlet air duct should be connected to each other in an airtight manner.

In addition, the wind resistance of the wind turbine or of parts thereof may be adjustable, in particular in that the setting angle of one or more blades or other wind-guiding surfaces is changeable. This can be done according to the speed of travel of the road vehicle and thereby according to the velocity of the airstream through the wind wheel. The conversion of wind energy into rotational energy can be controlled in this way. In this regard, the measures, listed by way of example, for influencing the wind resistance have different effects on the degree of conversion:

If the blades or other wind-guiding surfaces are preferentially set transversely with respect to the wind direction, the wind resistance and also the degree of conversion of wind energy into rotational energy increase; if these blades or wind-guiding surfaces are preferentially set in parallel to the wind direction, the wind resistance and also the degree of conversion of wind energy into rotational energy decrease.

According to the invention, it may be further provided that a freewheel is situated between a wind turbine and the electric generator associated therewith, so that in the event of a stop of the vehicle, the electric generator, despite the decelerated wind turbine, can continue to rotate freely in a practically undecelerated manner. In such cases, no energy is withdrawn from the rotating generator in case of a stop of the vehicle, thus further optimizing the efficiency.

An electrical rectifier—if necessary—should be a bridge rectifier, because then no energy is lost by the conversion from alternate current to direct current.

For the purpose of storing the energy of the generator on board of the regarding vehicle, the generator should either be a direct current generator or should on its output side be coupled to a rectifier to provide the electrical energy as direct current, because a direct current energy can be stored rather easily, compared to an alternating current energy.

For receiving and storing the electrical energy, at least one energy storage should be coupled to a direct current output of the generator or of the rectifier.

Like the wind wheel, the at least one energy storage is translationally movable in a horizontal or approximately horizontal direction. Especially, the at least one energy storage should be mounted in such way that a center of gravity of the energy storage is translationally movable in the same direction and with the same speed as the center of gravity of the wind wheel.

In order to hold the energy over a long period, if necessary, it is recommended that the at least one energy storage is a static storage for storing the fed electrical energy permanently.

A first embodiment of the invention is characterized in that the at least one energy storage comprises at least one capacitor for storing the fed electrical energy electrically, especially in the form of an electrical field. In such capacitors, the stored voltage can be substantially higher than the voltage of a battery, for example.

At another embodiment, it is provided that the at least one energy storage comprises at least one accumulator for storing the fed electrical energy electro-chemically. The advantage of an accumulator over a capacitor is the possibility to store the energy over days, weeks or months.

It is preferred that the at least one energy storage comprises at least one lithium ion accumulator.

the at least one energy storage comprises at least one apparatus for storing the fed electrical energy chemically, especially in the form of a chemical gas, liquid oder substance.

At least one apparatus for converting the fed electrical energy into a chemical gas, liquid oder substance comprises at least one electrolytic cell, especially an electrolytic cell for the fission of water, especially distilled water, into oxygen and hydrogen. Hydrogen is an element which can unite with oxygen to water, according to the following formula:

2H₂+O₂→2H₂O.

As oxygen can be found in the atmosphere in a sufficient amount, only the hydrogen has to be stored.

At least one apparatus for storing the fed electrical energy chemically comprises at least one storage tank for storing the electrolytically generated hydrogen. Such a storage tank—even if it is filled up to a pressure of about 200 bar, for example—has substantially less weight than an accumulator, where the same amount of energy is stored.

It has proven to be advantageous for the wind generator to be situated onboard a motorized road vehicle. This allows the wind generator and/or its wind turbine to be decoupled in terms of rotational movement from one or all of the bottom-side wheels of the road vehicle. In other words, the rotational energy of the wind turbine should not, or should not directly, be transmitted to the bottom-side wheels, since in such cases the efficiency of the system would be reduced. Instead, the vehicle or chassis is preferably provided with or coupled to a device, in particular a motor, for translationally driving same. An actively influenceable power flow to/from a motor provides the option of controlling or even regulating the translational movement corresponding to certain requirements.

The drive device may be designed as an internal combustion engine, as an electric motor, or as a propeller that is mounted so that it is rotatable about a vertical axis, and driven by a preferably upwardly directed convection flow. The type of motor depends on the type of primary energy used. The motor may be coupled in various ways in order to set the wind energy plant in translational movement. On the one hand, the bottom-side wheels of a vehicle or chassis may be driven directly by the motor, from which the translational movement of the vehicle or chassis is indirectly derived. On the other hand, the motor may be connected or coupled to the undercarriage of the vehicle or the chassis in order to drive it forward. On the one hand, a bracket or boom which connects a centrally situated motor to the vehicle or chassis that is movable along a circumferential periphery is conceivable; on the other hand, the coupling between the motor and the vehicle or chassis could also be established via a traction means, for example a cable, which extends along the length of the vehicle or chassis.

Preferably, a useful electric motor comprises at least one three-phase synchronous or asynchronous motor.

If the energy is stored in the form of a direct current, whereas a synchronous or asynchronous motor is used for driving the road vehicle as described above, at least one three-phase inverter should be interconnected between the electric output of the at least one energy storage and a three-phase synchronous or asynchronous motor, to provide the motor with a compatible form of energy.

A three-phase output of the the at least one three-phase inverter may be switchable to an output connector for exchanging electric energy between the energy storage and an external energy grid.

An optimum function can be achieved by a control device for switching the three-phase output of the at least one three-phase inverter either to an at least one three-phase synchronous or asynchronous motor, or to an alternating current output of the generator, or to an output connector for exchanging electric energy between the energy storage and an external energy grid. In such case, a single inverter can be used for several purposes.

An electric input and an electric output of a capacitor or accumulator can be conductively connected to each other, so that energy can flow in different directions dependent of the actual needs. In other words, a capacitor or accumulator can be actively charged or discharged as desired. Accordingly, a wind generator according to the present invention may include a device for feeding the obtained electrical energy as current into a power grid, in particular an alternating current power grid or three-phase power grid. Furthermore, in Central Europe, public three-phase power grids and alternating current power grids as a part of same are operated at a frequency of 50 Hz, whereas other countries such as the United States operate at 60 Hz. In any case, a device for synchronizing the current, to be fed, with the frequency of the voltage in the alternating current power grid or three-phase power grid is necessary. For this purpose, the current generated in a wind generator is typically transformed by an inverter or a converter to the frequency in question, and then injected into the grid, against the grid voltage. For this purpose, the grid voltage is customarily sampled, and on this basis the desired phase position of the current, and then also its amplitude, are computed, and the inverter or converter is then appropriately controlled, which takes place by suitable clocking of the current valves.

At least one storage tank for storing electrolytically generated hydrogen comprises an outlet duct which is coupled to a fuel cell. The purpose of the fuel cell is to transform chemically stored energy of electrolytically generated hydrogen into electrical energy. Preferably, the fuel cell comprises an electric output where direct current is provided.

In order to always be able to capture maximum incident air at any orientation of the wind turbine, a wind turbine according to the invention should not be situated within a wind tunnel or surrounded by wind deflector plates. In addition, a wind tunnel or the like could provide an increased wind exposure area in the event of an angled incident wind flow, thus entailing the risk of instability.

At a special embodiment, the rotational axis of the at least one wind wheel extends in a vertical direction.

A wind wheel with a vertical axis of rotation converts flow energy of wind into rotational energy independent of the flow direction of the wind. Therefore, such embodiment can generate energy even if the vehicle is not moving, if a wind strength is sufficient.

On the other hand, an at least one wind wheel with a vertical axis of rotation is designed to convert flow energy of the air stream of the translational moving wind generator into rotational energy independent of the translational moving direction of the wind generator. Therefore, the direction of movement must neither be parallel to the wind direction nor antiparallel to that.

It is preferred that the at least one wind wheel is designed to transport people and/or goods. Therefore, suitable vehicles are motor cars, buses and motor vans.

### BRIEF DESCRIPTION OF THE DRAWINGS

Further features, particulars, advantages, and effects based on the invention result from the following description of one preferred embodiment of the invention, with reference to the drawings, which show the following:

FIG. 1a shows a lefthand view, partly broken away, of road vehicle with two wind generators onboard, each wind generator comprising a wind wheel;

FIG. 1b shows a plan view of the road vehicle of FIG. 1a;

FIG. 2a shows a lefthand view, partly broken away, of another road vehicle with two wind generators onboard, each wind generator comprising a wind wheel;

FIG. 2b shows a plan view of the road vehicle of FIG. 2a;

FIG. 3 shows the wind wheel which is used in the wind generators used in the road vehicles according to FIGS. 1a to 2b;

FIG. 4a shows a block circuit diagram with relevant mechanic and electric components, which is incorporated in the road vehicles according to FIGS. 1a to 2b, where the wind wheel shown at the left side of FIG. 4a is the same as one of the wind wheels of FIGS. 1a to 2b, while the Motor shown at the right side of FIG. 4a is the same as that shown in the FIGS. 1a to 2b; wherein the electric components are incorporated onboard of the road vehicles according to FIGS. 1a to 2b, wherein the energy storage is an accumulator only;

FIG. 4b shows another block circuit diagram with relevant mechanic and electric components, which is incorporated in the road vehicles according to FIGS. 1a to 2b, where the wind wheel shown at the left side of FIG. 4a is the same as one of the wind wheels of FIGS. 1a to 2b, while the Motor shown at the right side of FIG. 4a is the same as that shown in the FIGS. 1a to 2b; wherein the electric components are incorporated onboard of the road vehicles according to FIGS. 1a to 2b, wherein—additional to the arrangement of FIG. 4a, a hydrogen generator, hydrogen tank and a fuel cell is provide in order to allow the road vehicles according to FIGS. 1a to 2b to store more energy in order to improve the cruising radius;

FIG. 5 shows a side elevation of road vehicle with a wind generator onboard having a wind wheel rotating around a horizontal axis in the direction of travel, which wind wheel is coupled to a generator;

FIG. 6 shows another embodiment with a wind wheel rotating around a vertical axis in a perspective similar to FIG. 5; and

FIG. 7 shows the wind wheel of the embodiment according to FIG. 6 in a perspective view.

### DETAILED DESCRIPTION OF THE PREFERRED EMBODIMENTS

As can be seen in the drawing, the wind generator 1, 1′, 1⁽³⁾, 1⁽⁴⁾ is situated onboard a vehicle 18 that is suitable for roadway travel, whereby this vehicle 18 is able to generate current from its kinetic energy, for example during a braking operation. For this purpose, such a wind generator 1, 1′, 1⁽³⁾ is preferably situated within the vehicle body 25, for example beneath the hood 58, and therefore has no negative effect on the air resistance of the road vehicle 18.

The wind generator 1, 1′, 1⁽³⁾ may be permanently active, or, when necessary, may be switched on as soon as excess kinetic energy is available, such as during a braking operation or during downhill travel. For this purpose, the wind generator 1, 1′, 1⁽³⁾ may be concealed behind a streamlined cowling which may be opened as needed, but which can be closed during acceleration operations or if a maximum travel speed is desired, in order not to generate any air resistance.

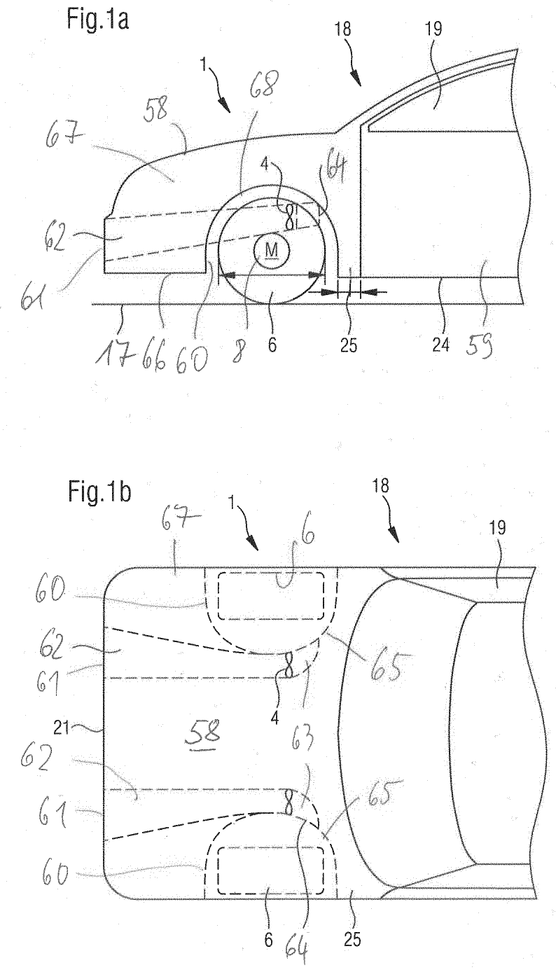

FIG. 1a shows the wind power plant 1 based on a side view of the front of the road vehicle 18 with an engine bonnet 58, a driver's cabin 19, and a driver's door 59, where a wind turbine 4 is fixed inside the car body 25, nearby a wheel case 60.

When the road vehicle 18 is in motion, overpressure is generated in front of the road vehicle 18 by the headwind. This overpressure causes the air in front of the road vehicle 18 to flow through an inlet mouth 61 of an air inlet duct 62 to the wind turbine 4, which is thereby driven in rotational motion, and produces electrical energy for the vehicle's electric accumulator 30 by use of an electric generator 5 coupled to the wind wheel 4. After passing through the wind wheel 4, the air is deflected by an air outlet duct 63 to an outlet mouth 64.

As the air outlet duct 63 terminates at the outlet mouth 64 inside of the wheel case 60, the distance between the wheel case 60 and the car body 25 can be less than the radius of the wheel 6, although the a maximum of space capacity is provided inside of the vehicle 18, especially inside of the driver's cabin 19.

As can be seen in FIG. 1b, one of two air inlet ducts 62 extends straight from the front of the road vehicle 18 backwards into the engine compartment nearby the regarding one of the two wheel cases 60 up to a wind wheel 4. Behind the wind wheel 4, the air is fed away via an air outlet duct 63 up to an outlet mouth 64 located at the medial side of the regarding wheel case 60, that is in the wall 65 separating the wheel case 60 from the engine compartment 66. The outlet mouth 64 is located in the upper rearward area or quarter of the wheel case 60, where the pressure is lower than the atmospheric pressure if the road vehicle 18 travels forward.

In order to prevent debris whirled up by the front wheel 6 inside of the wheel case 60 from damaging the wind wheel 4 or the generator 5 coupled thereto, the outlet mouth 64 may be covered by a grid or the like.

In the same manner, in order to prevent insects and the like contained in the headwind arriving at the front of the road vehicle 18 from damaging the wind wheel 4 or the generator 5 coupled thereto, the inlet mouth 61 may be covered by a grid or the like, too.

As can be seen from FIG. 1a, the inlet air duct 62 is slightly ascending towards the wind wheel 4.

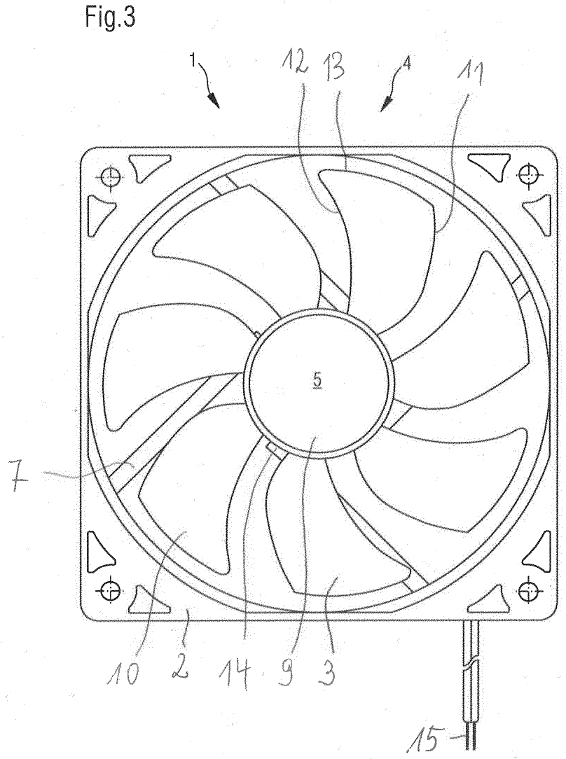

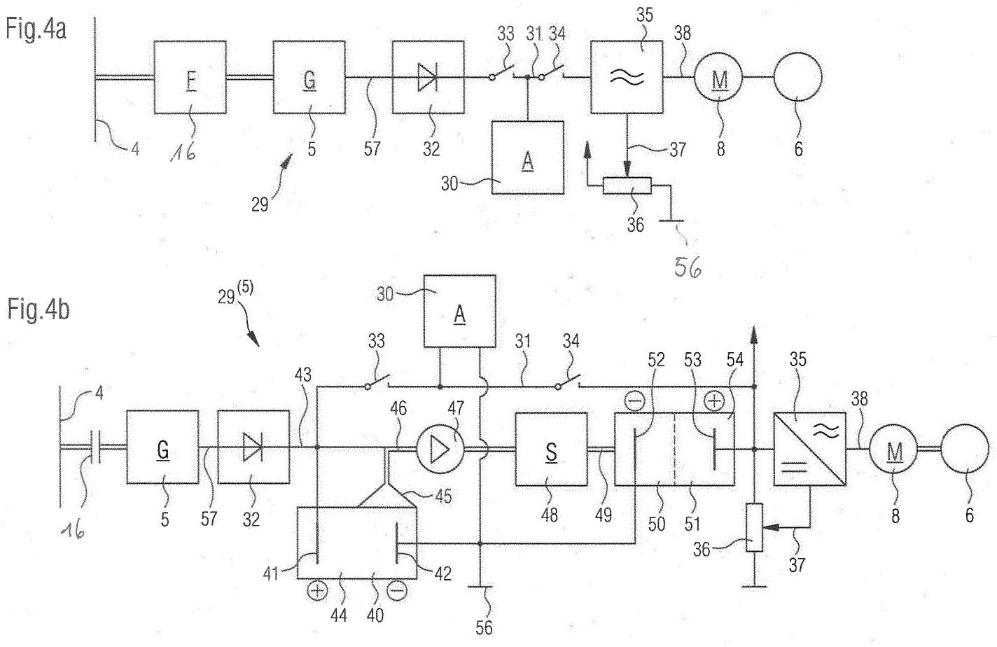

Furthermore, FIG. 1b shows that the cross section of the inlet air duct 62 narrows backwards towards the wind wheel 4 in order to increase the flow velocity there and therefore to move the wind wheel in an optimum speed range. The wind wheel 4 is shown in FIG. 3 and explained in the following. If necessary, the blades of the wind wheel 4 may be adjusted for an optimum conversion of energy from air flow through the wind wheel 4 to electric energy which can be stored in the accumulator 30 as shown in FIGS. 4a and 4b or as hydrogen gas in the hydrogen tank 48 as shown in FIG. 4b.

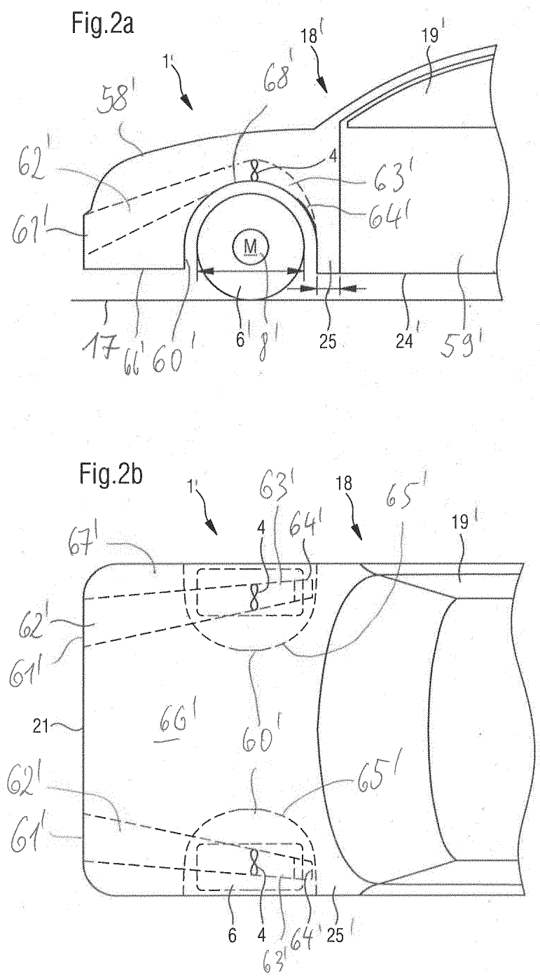

The only difference between the wind generator 1′ shown in FIGS. 2a and 2b and the wind generator 1 as already explained in view of FIGS. 1a and 1b is the location of the wind wheel 4′ and the inlet air duct 62′ and outlet air duct 63′ leading to and from the wind wheel 4′.

While in the embodiment according to FIGS. 1a and 1b, the wind wheel 4 is located in the engine compartment 66, between the both wheel cases 60, each near a wall 65 separating the regarding wheel case 60 from the engine compartment 66, in the embodiment according to FIGS. 2a and 2b, the wind wheel 4′ is located above a regarding wheel case 60 in the area of a mudguard or fender 67 of the road vehicle 18.

For this reason, the inlet air duct 62′ is steeper inclined than the inlet air duct 62 as shown in FIG. 1a.

In both embodiments, as shown in FIGS. 1a and 1b as well as shown in FIGS. 2a and 2b, the axis of rotation of the wind wheel 4, 4′ extends horizontally and is parallel to the direction of travel of the road vehicle 18.

A further difference between the two embodiments shown in FIGS. 1a, 1b on the one hand and FIGS. 2a, 2b on the other hand is that the outlet air duct 63 of the wind generator 1 is curved in a horizontal plane from a longitudinal direction nearly parallel to the direction of travel near the wind wheel 4 into a direction transverse to the direction of travel near the area of the outlet mouth 64, while the outlet air duct 63′ of the wind generator 1′ is curved in a vertical plane from a longitudinal direction nearly parallel to the direction of travel near the wind wheel 4′ into a nearly vertical direction near the area of the outlet mouth 64′.

The outlet mouth 64′ of the wind generator 1′ is located in the upper, curved wall 68 of the wheel case 60, especially in the rearward area of the wheel case 60, and can be protected against debris whirled up from the regarding front wheel 6 by a grid or the like.

In the same manner, in order to prevent insects and the like contained in the headwind arriving at the front of the road vehicle 18 from damaging the wind wheel 4′ or the generator 5′ coupled thereto, the inlet mouth 61′ may be covered by a grid or the like, too.

FIG. 3 shows a preferred embodiment of a wind generator 1 which is built into the vehicle 18 according to FIGS. 1a and 1b as well as into the vehicle 18 according to FIGS. 2a and 2b. It can be seen that the stator 2 is in the form of a chassis which can be fixed in the road vehicle 18, especially to the air inlet duct 62, 62′ and/or to the air outlet duct 63, 63′.

On the other hand, such chassis comprises the geometry of an outer ring surrounding the rotor, and comprises several spokes 7 running inwardly toward a hub-like element 14, where the rotor 3 is mounted in a pivotable manner.

The rotor 3 comprises a central hub 9, from which several blades 10 extend radially outwards. These have a two-dimensional shape with two nearly radial edges 11, 12 and a peripheral rim 13. All blades 10 are inclined from one radial edge 11 to the other 12 in the direction of the rotational axis of the rotor 3 or wind wheel 4, in order that air bouncing against the blades 10 in an axial direction cause a rotation of the wind wheel 4 in a predetermined direction.

Integrated with the hub-like element 14 of the stator 2 is a stator of the generator 5, while a rotor of the generator 5 is integrated with the hub 9 of the rotor 3 or wind wheel 4. Therefore, upon rotation of the wind wheel 4 or rotor 3, the generator 5 produces electric energy which is fed via a cable 15 to the accumulator 30 or to a rectifier, if the generator 5 is no direct current generator.

FIG. 4a discloses the electric standard circuitry 29 of a wind turbine 1 shown in FIGS. 1a and 1b as well as wind turbine 1′ as shown in FIGS. 2a and 2b. Although these two embodiments differ in a mechanic way of construction, the electric components are the same in both embodiments.

A central component of this circuitry 29 is an energy storage 28 in the form of an accumulator 30. The electric terminals 31 of such accumulator 30 can be coupled either to the regarding wind wheel 4 via—if necessary—a free-wheel 14, via the generator 5 and—if necessary, that is if the generator 5 does not generate a direct current at its output—via a rectifier 32 for converting an alternating current or a sinusoidal output voltage of the generator 5 into a direct current for charging the accumulator 30, if the switch 33 is closed, or, if switch 34 is closed, to at least one wheel 6 driven by a motor 8 via—if necessary, that is if the motor 8 is no direct current motor—an inverter 35 with an input where a potentiometer 36 can be connected for inputting a control voltage into the inverter 35 as a signal representing an acceleration command.

In the two embodiments according to FIGS. 1a to 2b, the motor 8 is shown directly mounted to the regarding front wheel 6. Normally, such wheel motors 8 are provided in pairs, either in one pair for the two front wheels or in two pairs for all four wheels 6 of the road vehicle 18.

The potentiometer 36 can be mechanically connected to an acceleration pedal which is operated by a driver of the vehicle 18, for example in such way that an increasing control voltage 37 leads to an increased mean value of output current or output voltage 38 of the inverter 35, so as to control the torque and/or speed of the motor 8.

In special cases where a recuperation of energy from the wheels 6 of a vehicle 18 is desired in case of a braking operation, the inverter 35 may comprise a second input where another potentiometer can be connected for inputting a second control voltage into the inverter 35 as a signal representing a deceleration command, and then the inverter 35 reduces its output voltage so that the motor 8 is operated as a generator and takes mechanical energy from the wheels 6 in order to brake the vehicle 18 while this energy is used to charge the accumulator 30.

The electric circuitry 29⁽⁵⁾ disclosed in FIG. 4b is amended over the standard circuitry 29 of FIG. 4a by an additional block 39 comprising several additional components which can be used to assist the accumulator 30 in storing energy. Therefore, the electric circuitry 29⁽⁵⁾ may be called a high-end version of the standard version 29 as shown in FIG. 4a. Especially, this can be considered as a measure to (virtually) enhance the charging capacity of the accumulator 30⁽⁵⁾ far beyond the charging capacity of the accumulator 30 in FIG. 8.

The additional block 39 comprises an electrolyse cell 40 with an anode 41 and a cathode 42, wherein preferably the anode 41 is connected to the output 43 of the rectifier 32 or—if the generator 5 is a direct current generator—directly to the output of the generator 5, while the cathode is connected to a common ground 56. The electrolyse cell 40 is a basin 44 filled with distilled water, into which the anode 41 and the cathode 42 are submerged. During operation of the electrolyse cell 40, oxygen bubbles are generated at the anode 41 and hydrogen bubbles at the cathode 42.

Such hydrogen bubbles are collected by a hood 45 which is located above the cathode 42. This hood 45 has an output at the elevated center of the hood 45, so that the hydrogen which is lighter than air is collected and fed to a duct 46 connected to that output

That duct 46 leads to a compressor 47 which feeds the compressed hydrogen gas to a pressure vessel 48 where the hydrogen can be stored, for example at a pressure of up to 200 bar.

In case energy is needed to drive one or more wheels 6 via the motor 8, hydrogen gas is fed via a duct 49 from an output of the pressure vessel 48 to a compartment 50 of a fuel cell 51, especially to a compartment 50 comprising an anode 52.

A cathode 53 is placed within a cathode compartment 54, and a membrane 55 is arranged between both compartments 50, 53. While the cathode 53 is connected to common ground 56, the anode 52 is or can be coupled to the input of the inverter 35.

If necessary, several electrolyse cells 40 may be connected in series, if the voltage at the output 43 of the generator 5 or rectifier 32 is substantially higher than the voltage at one electrolyse cell 40. On the other hand, several fuel cells 51 may be connected in series, if the voltage at one fuel cell 51 is substantially lower than the input voltage needed by the inverter 35.

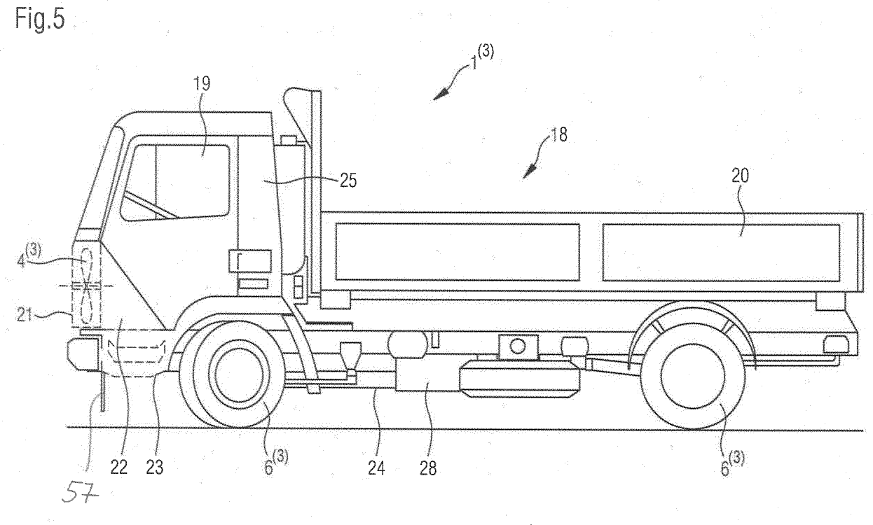

The wind power plant 1⁽³⁾ according to FIG. 5 is designed as a road vehicle or motor vehicle 18, for example as a transport vehicle like a lorry or motortruck with a driver's cabin 19 and a cargo area or load area 20. Other embodiments of such vehicle 18 are possible, for example as a passenger car or as a coach or bus.

In such vehicle 18, the wind wheel 4 may be installed behind the grill 21 in the front of the vehicle 18, with the rotational axis of the wind wheel 4 oriented in a horizontal direction, especially along the direction of travel of the vehicle 18. As can be seen from FIG. 5, there should be provided an air passage or ventilation duct 22 behind the wind wheel 4 to allow the inflow wind to leave the car body or the engine compartment after rotationally driving the wind wheel 4.

If the downstream mouth 23 of such air passage or ventilation duct 22 is at the bottom side 24 underneath the car body 25, where during movement of the vehicle 18 the pressure is below the atmospheric pressure, the pressure difference between inflowing air and outflowing air can be used to optimize the energy yield. The pressure is particularly low in the area of a diffusor or front spoiler 69 at the underside 24 of the vehicle 18.

The generated electric energy can be stored within an energy storage 28, specifically can be used to charge an accumulator on board of the vehicle 18. On the other hand, the energy storage 28 could be designed as a tank for storing hydrogen gas generated from water by electrolysis in an electrolytic cell onboard of the vehicle 18.

If the vehicle 18 comprises an electric drive motor, the additional electric energy can be used to extend the range of the vehicle 18 of one charge cycle. In case of a storage tank 28 for hydrogen gas, there could be provided a fuel cell onboard of the vehicle 18 for generating a current from the stored hydrogen gas to drive the vehicle 18

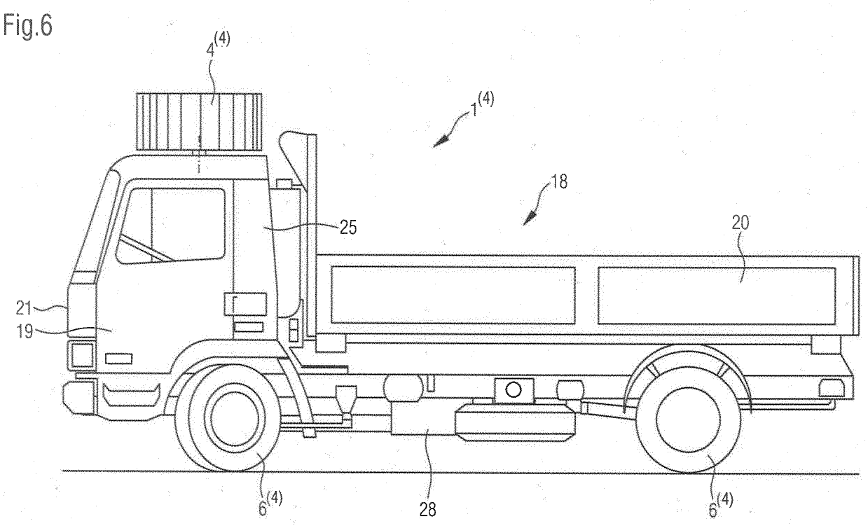

The wind power plant 1⁽⁴⁾ according to FIG. 6 is designed as a road vehicle or motor vehicle 18⁽⁴⁾, too. As a difference to the road vehicle or motor vehicle 18⁽⁴⁾, the wind wheel 4⁽⁴⁾ is not installed behind the grill 21 in the front of the vehicle 18⁽⁴⁾, but on top of the driver's cabin 19 of the vehicle 18⁽⁴⁾, and the axis of rotation 26 of the wind wheel 4⁽⁴⁾ is not oriented in a horizontal direction, but in a vertical direction.

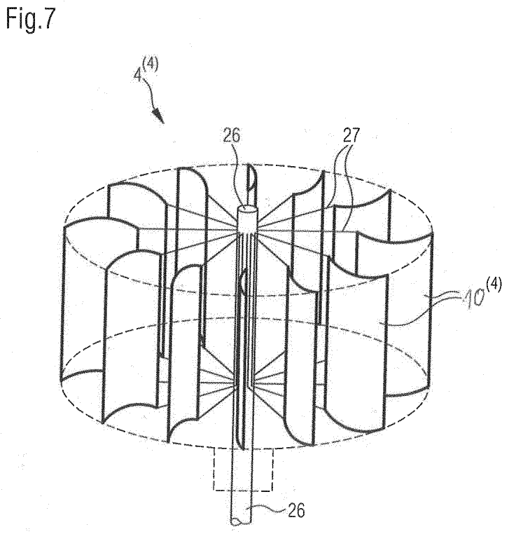

Such wind wheel 4⁽⁴⁾ itself Is shown in more detail in FIG. 7. It comprises beams 27 extending from the axis of rotation 26 radially outwards like radial spokes, especially in two planes above each other. The free ends of two such spokes or radial beams 27 of different planes each support a blade 15⁽⁴⁾ of the wind wheel 4⁽⁴⁾, and these blades 15⁽⁴⁾ have a curved cross section, so that an inflowing wind generates a higher pressure at the concave main surface of such blade 15⁽⁴⁾ than at its convex main surface.

Therefore, even if all blades 15⁽⁴⁾ of such wind wheel 4⁽⁴⁾ receive the same airstream, the pressure on such blades 15⁽⁴⁾ whose concave main surfaces face the airstream will be higher than the pressure on such blades 15⁽⁴⁾ whose convex main surfaces face the airstream, and the wind wheel 4⁽⁴⁾ will rotate in a direction where the convex main surfaces face into the direction of rotation, and the concave main surfaces will face against such direction of rotation.

For a wind wheel 4⁽⁴⁾ with a vertical axis of rotation 26, the direction of the inflowing air is not relevant. Therefore, even if the vehicle 18⁽⁴⁾ does not move, in case of a sufficient wind strength the wind wheel 4⁽⁴⁾ will generate rotational energy at its axis or rotation 26, which can be converted into electrical energy within a generator 5 coupled to the axis of rotation 26. For this purpose, the generator 5 can be installed at the top of the driver's cabin 19, either inside or outside.

The generated electric energy can be stored within an energy storage 28, specifically can be used to charge an accumulator on board of the vehicle 18⁽⁴⁾. On the other hand, the energy storage 28 could be designed as a tank for storing hydrogen gas generated from water by electrolysis via an electrolytic cell onboard of the vehicle 18⁽⁴⁾.

If the vehicle 18⁽⁴⁾ comprises an electric drive motor, the additional electric energy can be used to extend the range of the vehicle 18⁽⁴⁾ of one charge cycle. In case of a storage tank 28 for hydrogen gas, there could be provided a fuel cell onboard of the vehicle 18⁽⁴⁾ for generating a current from the stored hydrogen gas to drive the vehicle 18^{(4).}

List of reference numerals

| | | | |
|---|---|---|---|
| 1 | wind generator | 26 | axis of rotation |
| 2 | stator | 27 | radial beam |
| 3 | rotor | 28 | energy storage |
| 4 | wind wheel | 29 | electric circuitry |
| 5 | electric generator | 30 | accumulator |
| 6 | vehicle wheels | 31 | Electric terminal |
| 7 | spoke | 32 | Rectifier |
| 8 | motor | 33 | Switch |
| 9 | hub | 34 | switch |
| 10 | blade | 35 | inverter |
| 11 | edge | 36 | potentiometer |
| 12 | edge | 37 | control voltage |
| 13 | rim | 38 | output voltage |
| 14 | hub-like element | 39 | additional block |
| 15 | cable | 40 | electrolyse cell |
| 16 | free-wheel | 41 | anode |
| 17 | ground | 42 | cathode |
| 18 | vehicle | 43 | output |
| 19 | driver's cabin | 44 | bassin |
| 20 | load area | 45 | hood |
| 21 | grill | 46 | duct |
| 22 | ventialtion duct | 47 | compressor |
| 23 | downstream mouth | 48 | pressure vessel |
| 24 | bottom side | 49 | duct |
| 25 | car body | 50 | compartment |
| 51 | fuel cell | | |
| 52 | anode | | |
| 53 | cathode | | |
| 54 | compartmend | | |
| 55 | membrane | | |
| 56 | common ground | | |
| 57 | front spoiler | | |
| 58 | hood | | |
| 59 | driver's door | | |
| 60 | wheel case | | |
| 61 | inlet mouth | | |
| 62 | air inlet duct | | |
| 63 | air outlet duct | | |
| 64 | outlet mouth | | |
| 65 | wall | | |
| 66 | engine compartment | | |
| 67 | fender | | |
| 68 | wall | | |

1. A wind generator onboard of a road vehicle, the wind generator comprising:
at least one wind wheel which is mounted onboard of a road vehicle to be rotatable around a rotational axis, the at least one wind wheel comprising at least one or more blade configured to convert flow energy of wind into rotational energy,
at least one generator, the at least one generator being coupled to a hub or shaft of the at least one wind wheel or to an output shaft of a gear connected the at least one wind wheel, the at least one generator being configured to convert the rotational energy into electrical energy,
wherein a center of gravity of the wind wheel, together with a hub and rotor shaft and rotatable parts of the generator or of the gear which are coupled to the hub or rotor shaft and rotate around the same rotational axis, is translationally movable in a horizontal or approximately horizontal direction together with the road vehicle in the direction of travel,
wherein the at least one generator is either a direct current generator or is an alternating current generator with an output side of the at least one generator being coupled to a rectifier so as to provide the electrical energy as a direct current output,
wherein at least one energy storage is coupled to the direct current output of the at least one generator or to the direct current output of the rectifier, for receiving and storing the electrical energy,
wherein the extension of the at least one wind wheel parallel to its rotational axis is smaller than the extension of the at least one wind wheel transversely to its rotational axis,
wherein, in the direction of travel of the road vehicle, there is no cascade of more than one wind wheel, i.e. no two wind wheels are arranged behind each other, and
wherein the shape and size of the body of the vehicle are neither modified or increased by the wind generator nor affected by extensions fixed to the body of the vehicle housing the wind generator.

2. The wind generator according to claim 1, wherein the distance between the wheel case of the front wheel of the road vehicle and the regarding front door is less than the diameter of the front wheel, or is less than the radius of the front wheel.

3. The wind generator according to claim 2, wherein the air leaving the at least one wind wheel is fed via an outlet air duct along a direction towards or nearby at least one engine of the road vehicle to a region beneath the body of the road vehicle, where the pressure is lowered beneath the atmospheric pressure in case of movement of the road vehicle.

4. The wind generator according to claim 3, wherein the outlet air duct terminates in an outlet mouth beneath the body of the road vehicle.

5. The wind generator according to claim 4, wherein the outlet mouth of the outlet air duct is located behind a front spoiler of the road vehicle or in the wheel case of the front wheel of the road vehicle.

6. The wind generator according to claim 5, wherein the outlet mouth of the outlet air duct is located in the area of the rear half of the wheel case.

7. The wind generator according to claim 6, wherein the outlet mouth of the outlet air duct is located in the upper area of the wheel case or at the medial side of the wheel case, that is at the wall separating the wheel case from the engine compartment.

8. The wind generator according to claim 7, wherein the outlet mouth of the outlet air duct in the wheel case is covered by a grid in order to protect the wind wheel from debris.

9. The wind generator according to claim 7, wherein the outlet mouth of the outlet air duct in the wheel case is directed towards the wheel brake.

10. The wind generator according to claim 5, wherein the outlet air duct is curved between the wind wheel and the outlet mouth.

11. The wind generator according to claim 3, wherein the air entering the at least one wind wheel is fed via an inlet air duct from a region of the body of the road vehicle where the pressure is raised above the atmospheric pressure in case of movement of the road vehicle.

12. The wind generator according to claim 11, wherein the inlet air duct terminates in an inlet mouth in the front region of the body of the road vehicle.

13. The wind generator according to claim 12, wherein the inlet air duct is wider at the inlet mouth than at the wind wheel.

14. The wind generator according to claim 13, wherein the inlet air duct narrows continuously from the inlet mouth to the wind wheel.

15. The wind generator according to claim 12, wherein the inlet air duct is straight in an area between the inlet mouth and the wind wheel.

16. The wind generator according to claim 12, wherein the inlet air duct is ascending in an area between the inlet mouth and the wind wheel.

17. The wind generator according to claim 12, characterized by a device for closing the inlet air duct at the inlet mouth.

18. The wind generator according to claim 17, characterized in that the device for closing the inlet air duct at the inlet mouth is designed as a lamella-like curtain whose lamellae are open for a normal incident flow direction of the air, but closed to stop the incident flow of air onto the wind wheel.

19. The wind generator according to claim 3, wherein the at least one wind wheel has a front side facing towards the airflow coming into the wind wheel, and a rear side facing in the direction of the air leaving the wind wheel, and wherein the rotational axis of the wind wheel is parallel to the direction of the air flow between the front side and the rear side of the wind wheel.

20. The wind generator according to claim 19, characterized in that the wind generator and/or the wind wheel are/is mounted between an inlet air duct and an outlet air duct in such a way that the front side of the wind wheel faces the inlet air duct and the rear side of the wind wheel faces the outlet air duct.

21. The wind generator according to claim 20, characterized in that the inlet air duct and the outlet air duct are connected to each other in an airtight manner.

22. The wind generator according to claim 19, characterized in that a wind resistance of the wind wheel or of parts thereof is adjustable, in particular in that a setting angle of one or several blades or other wind-guiding surfaces is changeable.

23. The wind generator according to claim 22, characterized in that the blades of a the at least one wind wheel are adjustable about a longitudinal axis of the regarding blade in order to be adaptable to different relative speeds of incident air.

24. The wind generator according to claim 19, characterized in that a freewheel is situated between a wind turbine and the electric generator associated therewith, so that in the event of a stop of the road vehicle, the electric generator, despite the decelerated wind turbine, can continue to rotate freely in a practically undecelerated manner.

25. The wind generator according to claim 3, characterized in that the rectifier is a bridge rectifier.

26. The wind generator according to claim 3, characterized in that the at least one energy storage onboard of the road vehicle is a static storage for storing the fed electrical energy permanently.

27. The wind generator according to claim 26, characterized in that the at least one energy storage onboard of the road vehicle comprises at least one capacitor for storing the fed electrical energy electrically, especially in the form of an electrical field.

28. The wind generator according to claim 26, characterized in that the at least one energy storage onboard of the road vehicle comprises at least one accumulator for storing the fed electrical energy electrochemically.

29. The wind generator according to claim 28, characterized in that the at least one energy storage onboard of the road vehicle comprises at least one lithium ion accumulator.

30. The wind generator according to claim 26, characterized in that the at least one energy storage onboard of the road vehicle comprises at least one apparatus for storing the fed electrical energy chemically.

31. The wind generator according to claim 30, characterized in that at least one apparatus for storing the fed electrical energy chemically onboard of the road vehicle comprises at least one electrolytic cell, especially an electrolytic cell for the fission of water into oxygen an hydrogen.

32. The wind generator according to claim 31, characterized in that at least one apparatus for storing the fed electrical energy chemically onboard of the road vehicle comprises at least one storage tank for storing the electrolytically generated hydrogen.

33. The wind generator according to claim 3, characterized in that the road vehicle is driven by at least one engine which is designed as an internal combustion engine, or as at least one electric motor.

34. The wind generator according to claim 33, characterized in that an electric output of the at least one energy storage is electrically connected to the electric input of the at least one electric motor.

35. The wind generator according to claim 34, characterized in that the electric motor comprises at least one three-phase synchronous or asynchronous motor.

36. The wind generator according to claim 35, characterized in that at least one three-phase inverter is interconnected between the electric output of the at least one energy storage and the three-phase synchronous or asynchronous motor.

37. The wind generator according to claim 36, characterized in that a three-phase output of the the at least one three-phase inverter is switchable between the at least one three-phase synchronous or asynchronous motor, and an alternating current output of the generator.

38. The wind generator according to claim 37, characterized in that a three-phase output of the the at least one three-phase inverter is switchable to an output connector for exchanging electric energy between the energy storage and an external energy grid.

39. The wind generator according to claim 38, characterized by a control device for switching the three-phase output of the at least one three-phase inverter either to an at least one three-phase synchronous or asynchronous motor, or to an alternating current output of the generator, or to an output connector for exchanging electric energy between the energy storage and an external energy grid.

40. The wind generator according to claim 3, characterized in that an electric input and an electric output of a capacitor or accumulator are conductively connected to each other.

41. The wind generator according to claim 3, characterized in that at least one storage tank for storing electrolytically generated hydrogen comprises an outlet duct which is coupled to a fuel cell.

42. The wind generator according to claim 41, characterized in that the fuel cell is designed to transform chemically stored energy of electrolytically generated hydrogen into electrical energy.

43. The wind generator according to claim 41, characterized in that the fuel cell comprises an electric output where direct current is provided.

44. The wind generator according to claim 2, characterized in that the wind wheel is not surrounded by wind deflector plates.

45. The wind generator according to claim 44, characterized in that the rotational axis of the at least one wind wheel extends in a vertical direction.

46. The wind generator according to claim 45, characterized in that the at least one wind wheel converts flow energy of wind into rotational energy independent of the flow direction of the wind.

47. The wind generator according to claim 46, characterized in that the at least one wind wheel is designed to convert flow energy of the air stream of the translational moving wind generator into rotational energy independent of the translational moving direction of the wind generator.
